(19) United States
(12) Patent Application Publication
(10) Pub. No.: US 2012/0249777 A1
(43) Pub. Date: Oct. 4, 2012

(54) INSPECTION ARRANGEMENT AND INSPECTION METHOD FOR A SOLAR INSTALLATION

(75) Inventor: Sara Rentmeister, Buchenbach (DE)

(73) Assignee: TESTO AG, Lenzkirch (DE)

(21) Appl. No.: 13/435,251

(22) Filed: Mar. 30, 2012

(30) Foreign Application Priority Data
Mar. 31, 2011 (DE) 102011015701.8

(51) Int. Cl. H04N 7/18

(52) U.S. Cl. 348/125; 348/E07.085

(57) ABSTRACT

An inspection arrangement (1) for a photovoltaic or solar-thermal solar installation, in which a thermal image of the solar installation is captured using a thermal imaging camera (2) and a measurement value of a physical measurement variable characterizing the light or solar irradiation is measured on or near the solar installation or the exposure of the solar installation by a radiation sensor (7, 8) and the thermal image and the measurement value are assigned to one another in an evaluation unit (5) of the thermal imaging camera (2).

### CROSS-REFERENCE TO RELATED APPLICATIONS

This application claims the benefit of German Patent Application No. 10 2011 015 701.8, filed Mar. 31, 2011, which is incorporated herein by reference as if fully set forth.

### BACKGROUND

The invention relates to an inspection arrangement for a solar installation, having a thermal imaging camera configured to capture a thermal image of the solar installation to be inspected, and having an evaluation unit configured to further process the captured thermal image.

The invention furthermore relates to an inspection method for a solar installation, in which a thermal image of the solar installation during the operation thereof is captured using a thermal imaging camera.

Solar installations are known in the form of photovoltaic installations or solar-thermal installations and typically consist of individual modules that are combined to form an installation.

There often is the need for inspecting the function of the individual modules.

In order to monitor the function of the individual modules and to look for possible faults such as tears, coverings, breaks and the like, it has become conventional to record current-voltage characteristic curves of the modules during the operation thereof.

As a result, analyzing a whole module field becomes very complicated and requires a lot of time.

### SUMMARY

The object of the invention is to simplify the known inspection methods.

To this end, the invention provides that, in the case of an inspection arrangement of the type mentioned at the outset, a radiation sensor is designed for measuring at least one measurement variable by which the light or solar irradiation on or near the solar installation can be characterized, and that the evaluation unit has an input device, which is configured to enter measurement values of the measurement variable measured by the radiation sensor and assigned to the captured thermal image. An advantage of this is that this makes it easy to detect whether the environmental conditions that are expedient for operating the solar installation, more particularly expedient light or solar irradiation, are present. In this case, the measurement can be undertaken under artificial lighting, for example in a test installation, or under direct solar irradiation during operation. Here, the invention uses the discovery that production faults and damages to the modules lead to temperature deviations at the surface of the modules during normal operation, and these can quickly and easily be detected using a thermal imaging camera. By using an additional radiation sensor, which can, for example, be configured to measure the radiation power or the radiation intensity, it is possible to separate such temperature changes in the modules that are caused by an undesired impairment of the function from a temperature change in the modules due to insufficient illumination. As soon as the radiation sensor indicates illumination above a predetermined threshold, the assumption can be made that temperature deviations on the modules indicate a malfunction. The more radiation power is irradiated onto the modules, the more prominent these malfunctions become. This makes it possible to create fault images of the modules, indicating cells in the modules that may be e.g. erroneously in the idle state or defective. As a result of the assignment according to the invention of the measured measurement values to the captured thermal image, the present operating conditions can be documented in a simple manner, and so a subsequent evaluation of the recorded or captured thermal images is possible.

The radiation sensor can have an output unit for measurement values. In this case, it is advantageous if the measurement values for further processing are made available and can be entered e.g. manually or automatically into the evaluation unit by the input device.

For simple transfer of the measured measurement values to the evaluation unit, provision can be made for the input device to comprise a wireless or wired data connection between the radiation sensor and the evaluation unit. By way of example, the wireless data connection can be implemented by an infrared, WLAN, Bluetooth or another wireless data interface. The wired data connection can be implemented using one of the conventional wired data interfaces, e.g. as a USB data interface.

In one embodiment of the invention, provision can be made for the evaluation unit to be connected to a display unit. In this case, it is advantageous if the measurement results and the captured thermal image can be displayed directly in a simple manner.

Provision can also be made for the evaluation unit to be connected to a storage unit. Hence, the captured thermal image with the assigned measurement values can be stored for a subsequent evaluation or documentation.

In this context, provision can be made for the evaluation unit to be configured to display and/or to store a captured thermal image with assigned measurement value of the measurement variable. The assignment can be brought about by the measurement value being superposed onto the captured thermal image. The assignment can also be brought about by the measurement value and the thermal image being displayed spatially separately but simultaneously. The assignment can also be brought about by information being derived from the measurement value and being displayed and/or stored together with the captured thermal image.

Provision can be made for the evaluation unit to be integrated into the thermal imaging camera. Provision can likewise be made for the radiation sensor to be integrated into the thermal imaging camera. Provision can also be made for the display unit to be integrated into the thermal imaging camera. Any combinations of this are feasible. By way of example, the evaluation unit and the display unit can be integrated into the thermal imaging camera while the radiation sensor is arranged separately.

It is particularly expedient for the radiation sensor to be detachably arranged on the thermal imaging camera. Using this, the radiation sensor can be brought to the measurement or operation site of the solar installation in a simple manner, and the thermal imaging camera can capture a thermal image from the distance.

Additionally, or as an alternative thereto, provision can be made for the display unit to be detachably arranged on the thermal imaging camera. In this case, it is advantageous that a user can read out the measurement results from a comparatively freely selectable perspective. By way of example, this makes it possible, at a remote location from the thermal imaging camera, to read out the thermal image captured using the thermal imaging camera and/or the measured measurement value.

For the purpose of an inspection extending over a prolonged period of time and/or for an inspection under conditions that can be predetermined as precisely as possible, provision can be made for the inspection arrangement to comprise a holding device for the thermal imaging camera. This holding device is preferably embodied as a stand, which enables the thermal imaging camera to be set up or attached at many locations.

In order to simplify use or handling of the radiation sensor, provision can be made for the radiation sensor to have an attachment device for detachable attachment to the solar installation. By way of example, the attachment device can be configured for an attachment by clamping and/or screwing.

In order to warn a user if inadequate operating conditions are present, provision can be made for a comparison unit to be present, by which user information can be generated if the measurement value does not meet a predetermined tolerance criterion. Provision can also be made for the comparison unit to generate user information if the measurement value satisfies a predetermined tolerance criterion in order to indicate the presence of expedient operating conditions.

In order to achieve the aforementioned object, provision is made in an inspection method of the type described at the outset for a radiation sensor to be used to measure at least one measurement value of a measurement variable by which the light or solar irradiation on or near the solar installation can be characterized, and for the measurement value and the captured thermal image to be automatically linked. By way of example, this link can be configured and carried out by assigning the data contents to one another or by deriving new data by processing the thermal image and the measurement value or in another manner. The invention offers the advantage of enabling the user to perform a particularly low-error documentation of an inspection, which can be carried out in a quick and easy manner, of solar modules.

In general, within the scope of the invention, the solar installation can be embodied as a photovoltaic installation or as a solar-thermal installation.

In the case of photovoltaic installations in particular, material defects or damages result in high internal resistances and the like, which lead to undesired current flows that can easily be made visible using a thermal imaging camera as heating during operation.

Particularly in the case of manual entry of the measured measurement value to be linked with the captured thermal image, it may be advantageous for the measurement with the radiation sensor to be carried out before or after the capture of the thermal image.

However, particularly precise measurement results and a particularly meaningful link can be achieved if the measurement value is measured during the capture of the thermal image.

In order to avoid operating errors or erroneous measurements, provision can be made for user information to be generated if the measurement value linked to the thermal image satisfies or does not meet a tolerance criterion.

For the purpose of a subsequent documentation or evaluation of the measurements carried out, provision can be made for the measurement value and the thermal image to be stored in a state where they are assigned to one another. Hence, the automatic link is provided in a simple manner.

Provision can also be made for the measurement value and the thermal image to be displayed in a state where they are assigned to one another. By way of example, this can be brought about by superposing the measurement value onto the thermal image and/or by processing the measurement value and deriving information then displayed in the thermal image or in another manner.

For the purpose of an observation over prolonged periods of time, provision can be made for the thermal imaging camera to be displaced according to a predetermined movement path along a holding device for the purpose of capturing the thermal images or during the capture of said thermal images. By way of example, this makes it possible to cover large-area module fields in the manner of a scanner.

### BRIEF DESCRIPTION OF THE SEVERAL VIEWS OF THE DRAWINGS

The invention will now be explained in more detail on the basis of exemplary embodiments; however, it is not restricted to these exemplary embodiments. Further exemplary embodiments emerge by combining one or more features of the claims amongst themselves and/or with one or more features of the exemplary embodiments.

Shown are:

FIG. 1 is a three-dimensional perspective view from the front of a thermal imaging camera equipped according to the invention,

FIG. 2 is a three-dimensional perspective view from behind of the thermal imaging camera as per FIG. 1,

FIG. 3 is a schematic diagram of an inspection arrangement according to the invention, and

FIG. 4 is a schematic diagram of a further inspection arrangement according to the invention.

### DETAILED DESCRIPTION OF THE PREFERRED EMBODIMENTS

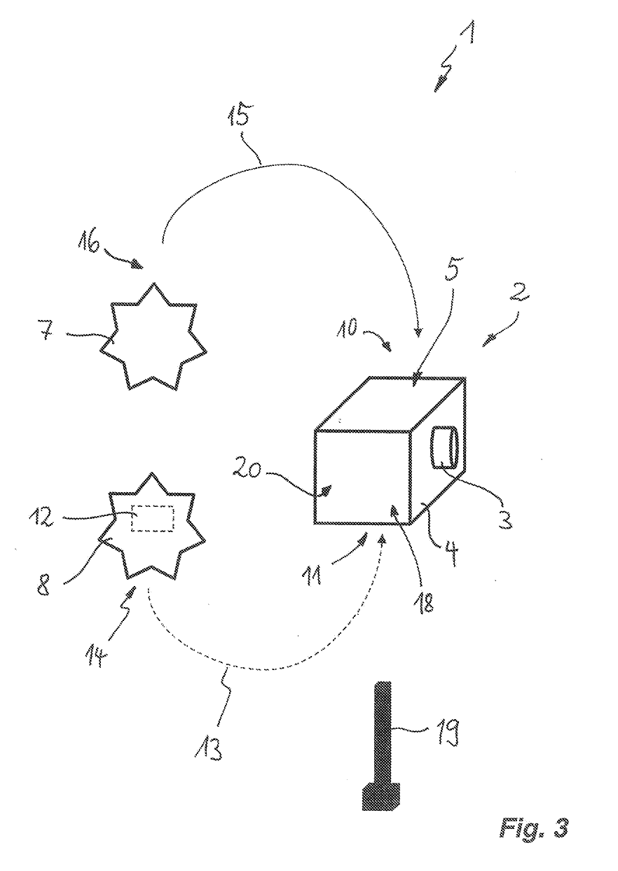

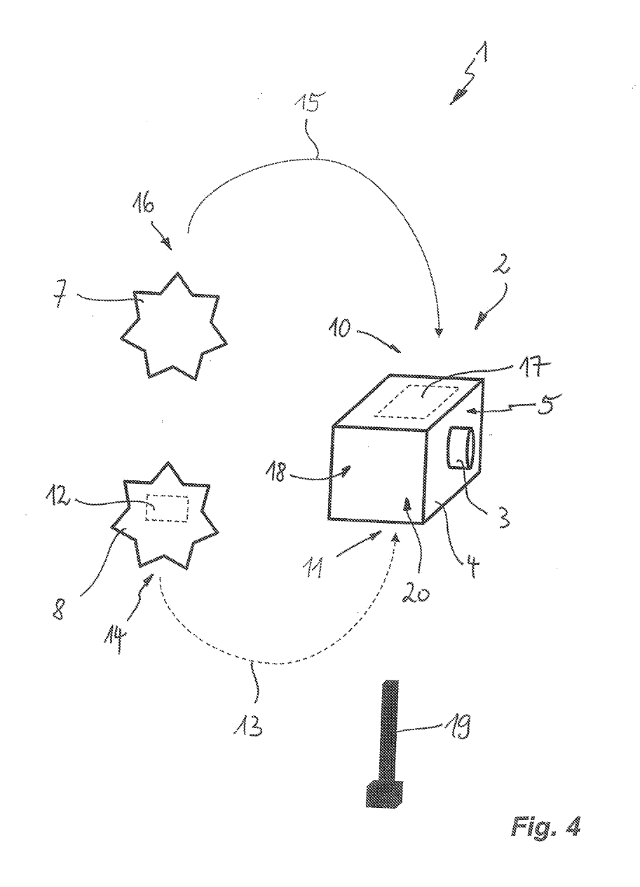

As a component of an inspection arrangement 1 explained in more detail in FIG. 3 and FIG. 4, FIG. 1 shows a thermal imaging camera 2.

The thermal imaging camera 2 has, in a manner known per se, an optical system 3 that is permeable to heat radiation, behind which an IR radiation detector for capturing a thermal image, using sensor field technology or scanner technology, is designed and arranged in the interior of the housing 4.

An electronic evaluation unit 5 is furthermore designed and arranged in the interior of the housing 4, by which evaluation unit the captured measurement values are configured in a manner known per se for creating a meaningful thermal image.

The thermal imaging camera 2 is designed as a portable hand-held instrument and has a handle 6 that can hold a rechargeable battery for operating the thermal imaging camera 2.

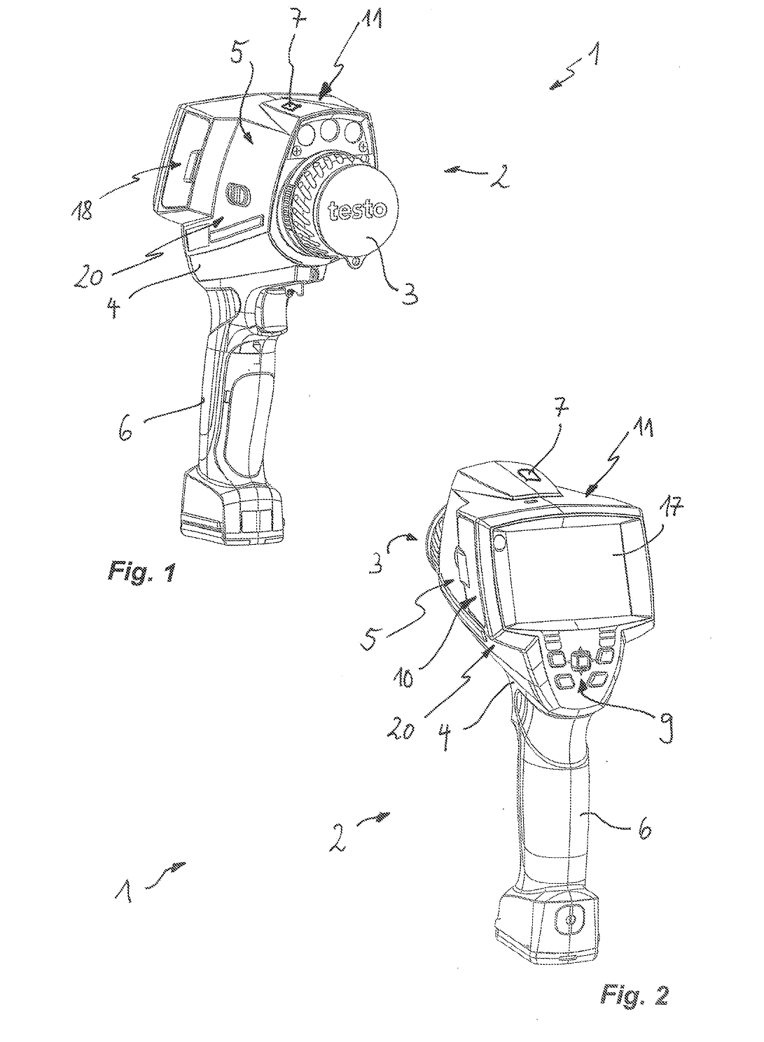

The thermal imaging camera as per FIG. 1 and FIG. 2 is a component of an inspection arrangement 1 shown in FIG. 3.

An inspection arrangement 1 comprises a radiation sensor 7, 8 in addition to the thermal imaging camera 2.

Each of the shown radiation sensors 7, 8 is designed to measure at least one measurement variable by which the incident light or solar irradiation can be characterized.

To this end, each of the radiation sensors 7, 8 has a light-sensitive sensor element (not illustrated in any more detail) by which a measurement signal can be generated that is dependent on the incident light power, light intensity or brightness.

During operation, each of the shown radiation sensors 7, 8 can be attached or arranged on a solar installation to be inspected or near this solar installation or at least with the same alignment as the solar installation. As a result of this, it is possible to derive a characterization of the light or solar irradiation on or near the solar installation from the aforementioned measurement signal.

The evaluation unit 5 has an input device 9, 10, 11, by which the measurement variable measured by the radiation sensor 7 or 8 can be entered into the thermal imaging camera 2 and, more precisely, into the evaluation unit 5.

In this case, the input device 9 is configured as a field of operating elements for manual entry of the measurement value measured by the radiation sensor 7 or 8.

Behind a hinged cover, the input device 10 is configured as a data interface for a wired data connection and/or for reading out a storage medium.

Finally, the input device 11 is designed as a data interface for a wireless data connection in the interior of the housing 4.

The radiation sensor 8 shown in FIG. 3 additionally has an output unit 12, by which the measured measurement values can be displayed.

The measurement values displayed thus can subsequently be entered manually into the thermal imaging camera 2, for example by the input device 9.

The radiation sensor 8 is connected to the input device 11 of the thermal imaging camera by a wireless data connection 13.

Hence, the measured measurement values of the measurement variable can be directly transmitted via the wireless data connection 13.

Thus, a further output unit 14 for operating the wireless data connection 13 is configured on the sides of the radiation sensor 8.

Compared to the radiation sensor 8, the radiation sensor 7 has a simpler design and does not have an optical output unit.

In order to transmit the measured measurement values via a wired data connection 15, the radiation sensor 7 is equipped with an output unit 16 which provides a data interface for the wired data connection 15.

The wired data connection 15 is connected via the input device 10 to the evaluation unit 5 for entering the measurement values.

FIG. 4 shows a further inspection arrangement 1 according to the invention, in which components with the same function and/or design as the inspection arrangement 1 as per FIG. 3 are denoted by the same reference signs and are not described again separately.

The inspection arrangement 1 as per FIG. 4 differs from the arrangement as per FIG. 3 in that the thermal imaging camera 2 additionally has a display unit 17, to which the evaluation unit 5 is connected.

The display unit 17 can—as shown in FIG. 2 in an exemplary manner—be embodied as a display.

Hence, the thermal image that was captured by the optical system 3 and processed in the evaluation unit 5 can be displayed on the display unit 17.

By contrast, the thermal imaging camera 2 as per FIG. 3 merely has a storage unit 18 (also present in FIG. 4) for storing the captured thermal images and the assigned measurement values of the measurement variable.

The storage unit 18 may comprise a removable memory card.

Thus, the evaluation unit 5 is configured to display and to store a captured thermal image with assigned measurement value of the measurement variable measured by the radiation sensor 7 or 8.

The radiation sensor 7 or 8 can—as shown in FIGS. 3 and 4—be embodied separately from the thermal imaging camera 2.

By contrast, in the exemplary embodiment as per FIG. 1 and FIG. 2, the radiation sensor 7 is integrated into the thermal imaging camera 2. This creates a particularly compact inspection arrangement 1, in which although the radiation sensor 7 does not measure precisely the light or solar irradiation incident on the solar installation to be inspected, the embodiment shown in FIG. 1 and FIG. 2 does supply approximate measurements that can already be utilized in many applications.

If the radiation sensor 7 in FIG. 1 is detachably arranged on the thermal imaging camera 2, the situation as per FIG. 3 or FIG. 4 can be obtained by removing the radiation sensor 7.

In a further exemplary embodiment, the display unit 17 is arranged on the thermal imaging camera 2 such that it can be detached or at least pivoted, and so the measurement results and the captured thermal image can be read out from different perspectives relative to the alignment of the thermal imaging camera 2.

The inspection arrangements 1 as per FIG. 3 and FIG. 4 furthermore comprise a holding device 19, to which the thermal imaging camera 2 can be attached by an attachment device (not illustrated in any more detail).

In the exemplary embodiments as per FIG. 3 and FIG. 4, the holding device 19 is embodied as a stand, onto which the thermal imaging camera 2 and/or the radiation sensor 7 or 8 can be detachably mounted.

In the case of further exemplary embodiments, the holding devices 19 additionally have motor-driven drives for displacing the mounted thermal imaging camera 2 along a predetermined movement path. This is how large-area solar installations can be measured using a predefined inspection pattern.

Furthermore, a comparison unit 20 is electronically implemented in the electronic evaluation unit 5; this comparison unit can be used to check the measurement values entered by the input device 9, 10 or 11 as to whether the measurement value satisfies or does not meet a predetermined tolerance criterion, for example whether it lies within or outside a predetermined tolerance interval. Depending on the test result, the comparison unit 20 is used to generate user information that can be displayed on the display unit 17 and/or perceived acoustically. By way of example, this user information can be configured as a warning in respect of inadequate light or solar irradiation on the currently inspected solar installation.

Hence, the inspection arrangement 1 can be used to carry out an inspection method for a solar installation, in which a thermal image of the solar installation during the operation thereof is captured using a thermal imaging camera 2, wherein before, after or during the capture of the thermal image at least one measurement value of the described measurement variable is measured by at least one radiation sensor 7, 8. The measured measurement value is fed to the evaluation unit 5 in the thermal imaging camera 2 via input device 9, 10 and/or 11 and is automatically linked by said evaluation unit to the captured thermal image.

If a check in a comparison unit 20 shows that the measurement value does not meet a tolerance criterion, a warning is output due to inadequate measurement conditions. By contrast, if the check of the measured measurement value in the comparison unit 20 shows that a tolerance criterion is satisfied, the presence of a meaningful measurement situation is indicated to the user.

The measurement of the measurement value and the capture of a thermal image are carried out continuously or repeatedly at regular time intervals, wherein the viewing direction of the thermal imaging camera 2 is modified between individual measurements as per a predetermined movement path by virtue of mounting the thermal imaging camera 2 on a holding device 19 equipped with a motor and moving said camera.

In the case of the inspection arrangement 1 for a photovoltaic or solar-thermal solar installation, it is provided to capture a thermal image of the solar installation using a thermal imaging camera 2 and to measure a measurement value of a physical measurement variable characterizing the light or solar irradiation on or near the solar installation or the exposure of the solar installation by means of a radiation sensor 7, 8 and to assign the thermal image and the measurement value to one another in an evaluation unit 5 of the thermal imaging camera 2.

1. An inspection arrangement (1) for a solar installation, comprising: a thermal imaging camera (2) configured to capture a thermal image of the solar installation to be inspected, and having an evaluation unit (5) configured to process further the captured thermal image, a radiation sensor (7, 8) for measuring at least one measurement variable by which the light or solar irradiation on or near the solar installation can be characterized, the evaluation unit includes an input device (9, 10, 11), which is configured to enter measurement values of the at least one measurement variable measured by the radiation sensor (7, 8) and assigned to the captured thermal image.

2. The inspection arrangement (1) as claimed in claim 1, wherein the radiation sensor (7, 8) has at least one of an output unit (12, 14, 16) for the measurement values or the input device (9, 10, 11) comprises a wireless (13) or wired (15) data connection between the radiation sensor (7, 8) and the evaluation unit (5).

3. The inspection arrangement (1) as claimed in claim 1, wherein the evaluation unit (5) is connected to at least one of a display unit (17) or a storage unit (18).

4. The inspection arrangement (1) as claimed in claim 1, wherein the evaluation unit (5) is configured to at least one of display or to store a captured thermal image with assigned measurement value of the measurement variable.

5. The inspection arrangement (1) as claimed in claim 1, wherein at least one of the evaluation unit (5), the radiation sensor (7, 8), or the display unit (17) is integrated into the thermal imaging camera (2).

6. The inspection arrangement (1) as claimed in claim 1, wherein at least one of the display unit (17) or the radiation sensor (7, 8) is detachably arranged on the thermal imaging camera (2).

7. The inspection arrangement (1) as claimed in claim 1, wherein the inspection arrangement (1) comprises a holding device (19) for the thermal imaging camera (2).

8. The inspection arrangement (1) as claimed in claim 1, wherein the radiation sensor (7, 8) has an attachment device for detachable attachment to the solar installation.

9. The inspection arrangement (1) as claimed in claim 1, wherein a comparison unit (20) is present, by which user information can be generated if the measurement value satisfies or does not meet a predetermined tolerance criterion.

10. An inspection method for a solar installation, comprising capturing a thermal image of the solar installation during the operation thereof using a thermal imaging camera (2), using a radiation sensor (7, 8) to measure at least one measurement value of a measurement variable by which light or solar irradiation on or near the solar installation can be characterized, and automatically linking the measurement value and the captured thermal image.

11. The method as claimed in claim 10, wherein the measurement value is measured during the capture of the thermal image.

12. The method as claimed in claim 10, further comprising generating user information if the measurement value linked to the thermal image satisfies or does not meet a tolerance criterion.

13. The method as claimed in claim 10, further comprising at least one of storing or displaying the measurement value and the thermal image in a state where they are assigned to one another.

14. The method as claimed in claim 10, further comprising displacing the thermal imaging camera (2) according to a predetermined movement path along a holding device (19) for capturing the thermal images or during capture of said thermal images.
